(19) United States
(12) Patent Application Publication
(10) Pub. No.: US 2014/0035723 A1
(43) Pub. Date: Feb. 6, 2014

(54) MOBILE APPLICATION SYSTEM AND METHOD

(71) Applicant: GENERAL ELECTRIC COMPANY, Schenectady, NY (US)

(72) Inventors: Adam A. ALFAR, Lawrence Park, PA (US); Sean L. CAHILL, Lawrence Park, PA (US); Edward F. MCQUILLAN, Lawrence Park, PA (US)

(73) Assignee: GENERAL ELECTRIC COMPANY, Schenectady, NY (US)

(21) Appl. No.: 13/894,488

(22) Filed: May 15, 2013

Related U.S. Application Data
(60) Provisional application No. 61/679,943, filed on Aug. 6, 2012.

(51) Int. Cl. G05B 1/01

(52) U.S. Cl. CPC G05B 1/01
USPC 340/5.65

(57) ABSTRACT

Systems and methods of the invention relate to authorize a driver to enter and/or exit a distribution center. A device associated with the driver communicates a request to enter and/or exit the distribution center in which a remote authentication component verifies in order to issue a confirmation. An interchange manager can grant access for exit and/or entry to the driver based on receipt of the confirmation via the device. Moreover, the device can request services from the distribution center as well as, or in the alternative receive message(s).

### CROSS-REFERENCE TO RELATED APPLICATIONS

This application claims the benefit of U.S. Provisional Application Ser. No. 61/679,943, filed Aug. 6, 2012, and entitled “MOBILE APPLICATION SYSTEM AND METHOD.” The entirety of the aforementioned application is incorporated herein by reference.

### BACKGROUND

1. Technical Field

Embodiments of the subject matter disclosed herein relate to access systems, such as a remote driver self check-in/check-out for a distribution center.

2. Discussion of Art

Some drivers of shipping vehicles bring shipments to, or take shipments from, a shipping terminal. The drivers may be checked in or checked out of the shipping terminal at a gate to process the shipments in and out of the shipping terminal. That person processing the check in/check out may inspect an associated shipping container or trailer to check for defects as part of the process. A driver of a shipping vehicle may have to exit the shipping vehicle to check in or check out of the shipping terminal. For example, a driver may have to exit his vehicle and enter an office at the entrance gate or exit gate of a shipping terminal and verbally provide certain information to a person within the office in order to check in or check out. Such current procedures can use an undesirable amount of time and manpower.

It may be desirable to have a system and method that differs from those systems and methods that are currently available.

### BRIEF DESCRIPTION

In one embodiment, a method is provided that includes at least the following steps: receiving a remote check-in request to enter a distribution center from a driver; validating an identity of the driver; confirming the remote check-in request based at least in part on the verification; and granting access into the distribution center to the driver based at least in part the confirmation.

In one embodiment, a system is provided that includes a device that transmits an authorization request on behalf of a driver for a distribution center, the device transmits the authorization request via a computer network. The device includes a first component operable to verify an identity of the driver and create an electronic confirmation based on the verified identity and to submit the electronic confirmation to the distribution center. The device includes a second component configured to grant at least one of an entry to the distribution center or an exit from the distribution center based at least in part on the submitted electronic confirmation so that the driver can enter or exit the distribution center to transport an asset based on at least in part on the electronic confirmation.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for securely pre-authorizing traffic within a distribution center;

FIG. 2 is an illustration of an embodiment of a system for utilizing a device to remotely authenticate access for entry or exit of a distribution center;

FIG. 3 is an illustration of an embodiment of a system for providing services to an authorized driver in a distribution center;

FIG. 4 illustrates a flow chart of an embodiment of a method for remotely checking-in with a distribution center for asset transport;

FIG. 5 illustrates a flow chart of an embodiment of a method for remotely checking-out with a distribution center for asset transport;

FIG. 6 illustrates a flow chart of an embodiment of a method for providing services to a driver from a distribution center for a duration of time or during use of a valid confirmation;

FIG. 7 illustrates a display screen of an embodiment of utilizing a device with a distribution center;

FIG. 8 illustrates a display screen of an embodiment of utilizing a device with a distribution center;

FIG. 9 illustrates a display screen of an embodiment of utilizing a device with a distribution center;

FIG. 10 illustrates a display screen of an embodiment of utilizing a device with a distribution center;

FIG. 11 illustrates a display screen of an embodiment of utilizing a device with a distribution center;

FIG. 12 illustrates a display screen of an embodiment of utilizing a device with a distribution center;

FIG. 13 illustrates a display screen of an embodiment of utilizing a device with a distribution center;

FIG. 14 illustrates a display screen of an embodiment of utilizing a device with a distribution center;

FIG. 15 illustrates a display screen of an embodiment of utilizing a device with a distribution center;

FIG. 16 illustrates a display screen of an embodiment of utilizing a device with a distribution center; and

FIG. 17 illustrates a display screen of an embodiment of utilizing a device with a distribution center.

### DETAILED DESCRIPTION

Embodiments of the invention relate to methods and systems for securely pre-authorizing traffic within a distribution center. In particular, a device can communicate a remote request for authorization to enter and/or exit the distribution center. Upon verification of the request, a confirmation can be communicated to the device, wherein the confirmation can be utilized to access exit and/or entry to the distribution center. The distribution center can further provide services to a driver via the device based upon a request such as, but not limited to, a repair service, equipment service, query requests, and the like. Moreover, the distribution center can broadcast a message to the device. In still another aspect, geographic locations of the driver can be employed to provide estimates on arrival and/or departure, as well as, or in the alternative, scheduling for the driver(s).

With reference to the drawings, like reference numerals designate identical or corresponding parts throughout the several views. However, the inclusion of like elements in different views does not mean a given embodiment necessarily includes such elements or that all embodiments of the invention include such elements.

The term “client asset” as used herein means a fixed asset or a mobile asset that is owned and/or operated by a client entity such as, for example, a railroad, a power generation company, a shipping company (e.g., land, sea, air, and/or a combination thereof), a mining equipment company, an airline, or another asset-owning and/or asset-operating entity. The term “vehicle” as used herein can be defined as an asset that is a mobile machine that transports at least one of a person, people, or a cargo. For instance, a vehicle can be, but is not limited to being, a rail car, an intermodal container, a locomotive, a marine vessel, mining equipment, a stationary power generation equipment, an industrial equipment, a construction equipment, and the like. The terms “container” and “trailer” may be used interchangeably herein and refer to a storage medium configured to hold products, goods, or other shippable materials. The terms “terminal”, “yard”, or “distribution center” may be used interchangeably herein and refer to a location and/or facility where products, goods, or other shippable materials are shipped into and subsequently shipped out of by drivers of shipping vehicles. The terms “equipment interchange receipt” or “electronic equipment interchange receipt” may be used interchangeably herein and refer to a confirmation that includes information related to a transport of an asset within a distribution center.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like. “Computer” or “processing element” or “computer device” as used herein includes, but is not limited to, a programmed or programmable electronic device that can store, retrieve, and process data. “Non-transitory computer-readable media” include, but are not limited to, a CD-ROM, a removable or non-removable flash memory card, a hard disk drive, a magnetic tape, and a floppy disk. “Computer memory”, as used herein, refers to a storage device configured to store digital data or information which can be retrieved by a computer or processing element. “Controller”, as used herein, refers to the logic circuitry and/or processing elements and associated software or program involved in controlling an energy storage system. The terms “signal”, “data”, and “information” may be used interchangeably herein and may refer to digital or analog forms.

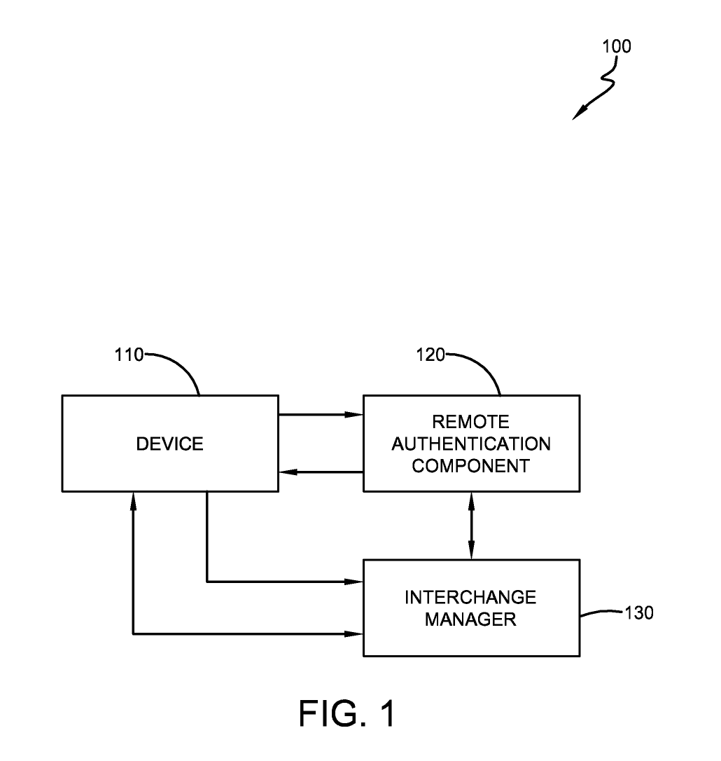

FIG. 1 is an illustration of an embodiment of a system 100 for securely pre-authorizing traffic within a distribution center. The system 100 can include a device 110 that utilizes a computer network connection (e.g., Internet connection) to authorize with a distribution center via a remote authentication component 120. In particular, a driver (e.g., a drayage driver, a long-haul driver, an employee, and the like) can receive authorization to exit and/or enter the distribution center ahead of time (e.g., prior to a point in time and/or space when the driver exits and/or enters the distribution center). Upon receiving authorization via the device 110 and the Internet connection, the driver can utilize the device 110 to enter and/or exit the distribution center based upon an interchange manager 130 validating the authorization received on the device 110. By way of example and not limitation, the device 110 can be a portable device and can be at least one of a smartphone, a mobile device, a portable device, a portable digital assistant (PDA), a tablet, a wireless device, a wireless fidelity (Wi-Fi) device, a Wi-Fi equipped device, a laptop, a portable gaming device, a device that connects to the Internet, a device with a computer network connection (e.g., an Internet connection) and a display, among others. The remote authentication component 120 and/or the interchange manager 130 can be separate components (as illustrated), the interchange manager 130 can be incorporated into the remote authentication component 120, the remote authentication component 120 can be incorporated into the interchange manager 130, and/or a suitable combination thereof.

The device 110 can communicate a remote check-in request to the remote authentication component 120. The remote check-in request may be, for example, a data package that includes information items determined to be useful in confirming, or denying, access or exit from a distribution center or other location. Non-limited examples of such information items may include identification (biometric or otherwise), license, inspection status, cargo, digital certificates, vehicle registration, and the like. The remote check-in request may be electronically-storable and/or electronically-communicated. In one embodiment, the remote check-in request may be encrypted.

Upon verification of the remote check-in request and/or a source for the request (e.g., a driver, a cargo, equipment associated with the driver, and the like), the remote authentication component 120 can generate a confirmation (electronically-storable and/or electronically-communicated authorization to access a distribution center or other location). The confirmation can be communicated to the device and, in turn, the confirmation can be utilized by the driver to check in to (e.g., enter, arrive, exit, and the like) the distribution center. That is, the interchange manager can validate the confirmation, stored on the device or otherwise communicated to the interchange manager, for controlling access to the distribution center or other location in question. Thus, the device, the remote authentication component, and the stored confirmation allow a driver to check-in prior to being physically located at the entrance of the distribution center. The system may enable a driver to check-in without physical paperwork. The confirmation provides verification of a valid identity of a driver, cargo, and vehicle at a valid location/time.

Similarly, the device can communicate a remote check-out request to the remote authentication component. Upon verification of the remote check-out request and/or a source for the request (e.g., a driver, a cargo, equipment associated with the driver, and the like), the remote authentication component can generate an exit confirmation. The exit confirmation can be communicated to the device and, in turn, the exit confirmation can be utilized to check-out (e.g., depart, leave, exit, and the like) the distribution center. Thus, the device 110, the remote authentication component, and the exit confirmation allow a driver to check-out prior to being physically located at the exit of the distribution center. Moreover, the system may enable a driver to check-out without physical paperwork. The exit confirmation can confirm authorized exit of the distribution center.

With reference again to remote check-in request and/or check-out request, either can include at least one of a name of the driver, a cargo for the driver, a company employing the driver, a license number for the driver, cargo information (e.g., type of cargo, weight of cargo, destination of cargo, origination of cargo, cost of cargo, and the like), driver information (e.g., age, experience, license number, origination of transport, destination of transport, employer, history of visits, record of incidents, billing information, payee information, email address, address, contact information, username, and the like), equipment information (e.g., size, length, brand, year, model, owner, lessor, lessee, and the like), or distribution center information (e.g., contact information, map information, asset location information, service contact(s), and the like).

The confirmation can be in any format or configuration suitable for communication by the remote authentication component 120 to the device 110 and subsequent utilization to grant access and/or exit with the distribution center. The confirmation can be electronically communicated and/or electronically stored/storable, digitally formatted, or the like. By way of example and not limitation, the confirmation can be at least one of a password, a pass code, a pass phrase, a confirmation number, a confirmation code, a Quick Response (QR) code, a barcode, a 3-dimensional (3D) barcode, a data file, an audio file, an image file, or a synchronized hardware token, among others. In one embodiment, the confirmation includes multiple distinct verification aspects, for verification by way of a combination of methods. For example, the confirmation may be a code generated by a synchronized hardware token and a password; or, an identity magnetic strip and a biometric sensor reading.

The confirmation can be submitted to the distribution center for access to exit, enter, enter and exit, exit and enter, and/or a suitable combination thereof. In particular, the confirmation can be submitted by the device 110 (e.g., via the driver) to the interchange manager 130. Thus, the interchange manager 130 can grant access for entry and/or exit to the distribution center based upon the receipt of the confirmation and/or validation thereof. The confirmation can include information related to a transport of an asset within the distribution center (e.g., equipment interchange receipt, location of asset, location of pickup, location of drop off, location of transport, receipt of transport, receipt of pickup, receipt of drop off, bill, invoice, map of distribution center, services provided by the distribution center, and the like) and verification and validation information about the transaction. For instance, a transport can be a movement of an asset from a first location to a second location. Moreover, the transport can be a pickup, a drop off, and/or a suitable combination thereof.

For receipt and/or validation of the confirmation, the confirmation (previously communicated by the remote authentication component) is communicated (from the device and/or driver or other human operator) to the interchange manager and, in turn, the distribution center. For instance, the communication of the confirmation can be a physical communication (e.g., entering the confirmation via a computer, typing the confirmation in a keypad, and the like), an audible communication (e.g., reading the confirmation, playing an audio file with the confirmation, and the like), a visual confirmation (e.g., rendering the confirmation, displaying the confirmation, and the like), and/or an electronic communication. Thus, the receipt or communication of the confirmation from the device to the interchange manager (and/or the distribution center) can be at least one of a scan communication (e.g., scanning of a barcode, a Quick Response (QR) code, a graphic, and the like), a wireless transmission (e.g., cellular communication, Wi-Fi, and the like), a Near Field Communication (NFC), a Radio Frequency Identification (RFID) communication, short-wavelength radio transmission, a visual receipt (e.g., employee visually checking the confirmation, and the like), a camera (e.g., automatically evaluating the confirmation via still photos or video, and the like), among others.

The system may allow a driver at a gate to initiate an information exchange. This may be done via paper (particularly if using Optical Character Recognition (OCR)), tablet, smart phone, Radio Frequency Identification (RFID), and the like to check in or check out. This may improve the efficiency of a drayage driver or other driver and the interaction that may occur when the vehicle arrives at a gate of a distribution center. This information exchange can provide information as to where to go to dock and/or pick up (or drop off). The system may provide transport information regarding an asset within the distribution center. The system may provide advanced check-in functions for informing the distribution center of a location as well as an estimated time of arrival (e.g., ETA, predicted arrival time, and the like). This can trigger a preparation to retrieve a load/container and deliver it to a pick-up point, with the pick-up info relayed back to the driver.

In one embodiment, the system can use an electronic device receipt process rather than a paper process, and can populate data to a back office system directly. The distribution center can broadcast messages (e.g., alerts, delays, weather, other status, security alerts, safety levels, backlogs and traffic jams, among others). The system may allow inquiries from a driver about location, availability/status of a loading dock or pick-up point, the equipment to lift/load a container, a pump to transfer liquid cargo, among others. The system may employ Automatic Equipment Identification (AEI), Global Positioning Services (GPS) location tracking, or the like to enhance security and reduce delivery errors. The system may track a service request incoming (e.g., fuel, repairs, breaks/down time, and the like).

By way of example and not limitation, the distribution center can be a shipping terminal, a railroad intermodal terminal, a yard, a loading/unloading dock, and/or a location and/or facility where products, goods, or other shippable materials are shipped into and subsequently shipped out of by drivers of shipping vehicles. The containers or trailers containing the products, goods, or materials are processed in and out of the distribution center. Within application-specific constraints, the equipment can be a suitable mobile asset or vehicle that transfers assets from one location to another where the equipment includes a load capacity. By way of example and not limitation, the transfer of an asset for a transport (e.g., a movement from a first location to a second location) can be handled or completed by a worker (e.g., employee, human, user, or two or more workers, among others), by a equipment (e.g., vehicle, mobile machine, crane, machine, forklift, employee controlling the equipment, or machine-controlled equipment, among others), or by equipment being operated remotely.

As an option, the system may include a wireless communication (COMM) device (not shown) operably interfacing to the device and configured to communicate with other wireless devices (e.g., via radio frequency communication) operating within the distribution center (e.g., remote authentication component, interchange manager, among others). Such other wireless devices may be hand-held devices used by inspectors, or may be located in cranes or other on-site transportation vehicles within the shipping terminal, and are configured to communicate with at least one of the remote authentication component or the interchange manager.

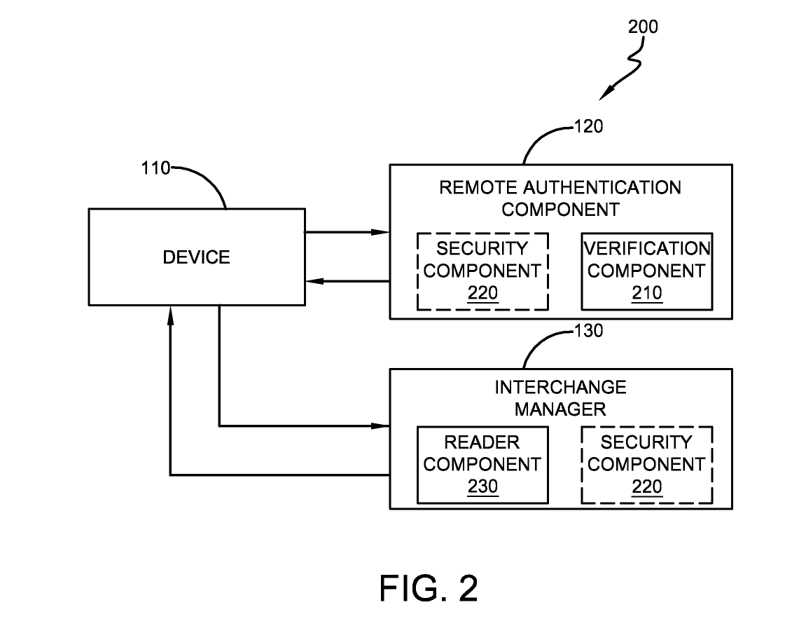

FIG. 2 is an illustration of an embodiment of a system 200 for utilizing a device to remotely authenticate access for entry or exit of a distribution center. The system can include the remote authentication component that can generate and communicate a confirmation to the device based upon verification thereof. The confirmation can be communicated ahead of time in order to expedite a check-in and/or check-out process for the distribution center and a driver. The driver can request a check-in and/or a check-out in which the remote authentication component can respond with a confirmation upon validation of at least one of an identity of the driver or a cargo of a driver (e.g., driver of equipment with cargo, and the like). The device can utilize the confirmation for at least one of a check-in or a check-out with the distribution center. For instance, the device can receive the confirmation upon validation (from the remote authentication component) prior to exit and/or entry to the distribution center and employ such confirmation for entry and/or exit upon physically being located at an entrance and/or exit of the distribution center (via the interchange manager).

By way of example and not limitation, the receipt of a confirmation code by the interchange manager can grant access for entry and/or exit of the distribution center. For instance, the interchange manager can validate the confirmation received by the device. For example, the confirmation can be checked to ensure the confirmation matches the driver and/or the device, the confirmation can be checked for expiration, and the like. In addition, the interchange manager can utilize the receipt of the confirmation from the device as a trigger to provide at least one of the following: communication of a receipt for the transport by the driver; a timestamp for arrival and/or departure of the driver; a communication of equipment interchange receipt to driver; a communication of equipment interchange receipt to employer of driver; a communication of equipment interchange receipt to owner of assets being transported; a start or a stop of geographic tracking service for the driver; directions to a location; directions to an asset; instructions for a transport; timing information, destination information for asset; among others.

The remote authentication component can include a validation component that verifies at least one of the remote check-in request, the remote check-out request, a driver, a cargo, equipment for a driver, among others. Upon verification of the validity of the request (e.g., remote check-in request, remote check-out request), the remote authentication component can issue a confirmation that is communicated to the device. The validation component 210 can receive at least one of the remote check-in request or the remote check-out request from the device and, in turn, a driver. As discussed above, the remote check-in request and/or the remote check-out request can include information of which the verification component can validate. The verification component can validate at least one of a driver, a cargo of the driver, equipment controlled by the driver, and/or a suitable security protocol to ensure protective monitoring over traffic within the distribution center.

The validation component can further validate using personal identification information from the driver which can be linked to incoming and/or outgoing assets from the distribution center. In other words, the validation component can verify an identity of a driver, which in turn can be verified if the driver is to be picking up and/or dropping off according to distribution center record(s). In such a situation, the validation component can utilize personal identification information such as, but not limited to, fingerprint, retinal scan, inductance detection, handprint, face detection, voice detection, identification number (e.g., social security number, driver license number, employee ID, etc.), username, personal pass code, and the like.

The system can include a security component that employs security techniques to ensure secure communications within the system and/or to ensure authenticity of confirmations issued, requests received, and the like. The security component can be a distributed component between the remote authentication component and the interchange manager (as depicted), a stand-alone component, a component incorporated into the remote authentication component, a component incorporated into the interchange manager, and/or a suitable combination thereof

The security component 220 can employ a timestamp to secure the system. For instance, the timestamp can be utilized with the confirmation issued to the device and/or at least one of the remote check-in request or the remote check-out request. For example, the security component can utilize a timestamp with the confirmation issued for a request from the device. For instance, the confirmation can be embedded with a timestamp in which the confirmation can expire after a designated duration of time. The timestamp and expiration can be issued based upon a predicted expected time for transport (e.g., estimate based on location/distance of driver from asset) with a buffer time (e.g., padded time to account for miscellaneous issues). Expiration of the timestamp may trigger a check to see if an expected exit has occurred. If the expected exit has not occurred additional steps may be taken, such as an alert issued or additional checks made.

The security component can provide the following security techniques with at least one of the confirmation, the remote check-in request, or the remote check-out request: encryption, QR code security, Human Interactive Proofs (HIPs), digital signatures, embedded signatures, embedded codes, key/public key, cryptography techniques, among others.

The interchange manager can further include a reader component 230 that can receive the confirmation from the device. As discussed above, the reader component 230 can receive the confirmation by at least one of a scan communication (e.g., scanning of a barcode, a QR code, a graphic, and the like), a wireless transmission (e.g., cellular communication, Wi-Fi, and the like), a Near Field Communication (NFC), a Radio Frequency Identification (RFID) communication, short-wavelength radio transmission, a visual receipt (e.g., employee visually checking the confirmation, and the like), a camera (e.g., automatically evaluating the confirmation via still photos or video, and the like), among others. The reader component 230 can be an NFC reader, RFID reader, still camera, video camera, wireless receiver, keypad, or barcode reader, among others. Some suitable cameras operate in the visible light spectrum, while others may operate in the infrared, ultraviolet, x-ray, or at another part of the EM spectrum. The reader component can be selected based on application specific requirements.

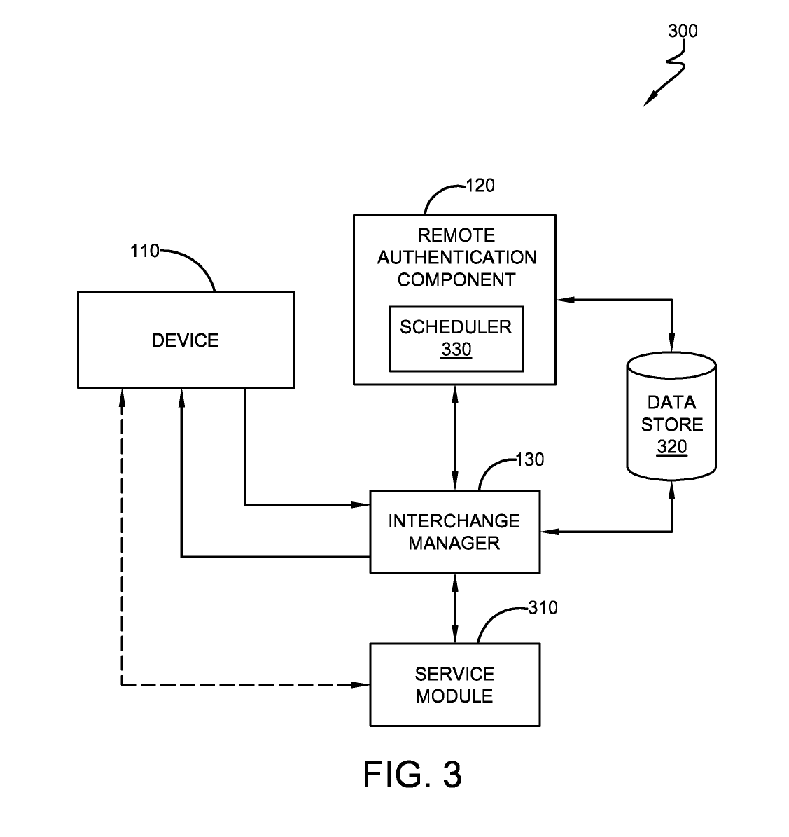

FIG. 3 is an illustration of an embodiment of a system 300 for providing services to an authorized driver in a distribution center. The system can further include a service module 310. The service module can communicate with the device 110 (and, in turn the driver associated with the device). The service module can receive communications from the device related to, but not limited to, repair requests (e.g., chassis repair, container repair, trailer repair, and the like), service requests (e.g., remount to chassis, mounting, and the like), equipment services, asset location queries, map queries, distribution center location queries, among others. The service module can respond to such requests by at least one of the following: dispatching a service crew to the driver, dispatching an employee of the distribution center to the driver, communicating a query result to the driver, communicating a message to the driver (e.g., an email, an alert, among others), relaying a message from the driver to a third-party (e.g., a third-party being an entity other than the driver and the distribution center), and the like.

In one embodiment, the remote authentication component and/or the interchange manager stores information related to the system in a data store 320. The data store can include driver information, asset information, equipment interchange receipts, confirmations, transport information (e.g., incoming and/or outgoing schedule for assets within the distribution center), security information, historical data related to previous transports by drivers, device registration, map information, asset locations, directions within distribution center, and/or a suitable combination thereof.

The data store can be, for example, either volatile memory or nonvolatile memory, or can include both volatile and nonvolatile memory. The data store of the subject systems and methods is intended to comprise, without being limited to, these and other suitable types of memory. In addition, the data store can be a server, a database, a hard drive, flash drive, an external hard drive, a portable hard drive, a solid state drive, cloud-based storage, and the like.

The remote authentication component can include a scheduler 330 that can utilize receipt of the remote check-in request and/or the remote check-out request to predict transport by the driver within the distribution center. For example, a geographic location can be ascertained based upon the receipt of a remote check-in request and/or a remote check-out request (e.g., ascertained by providing location in the request, determining the location based on Internet Protocol (IP) address, triangulation techniques for a cellular device, among others). The geographic location can be utilized to estimate or predict a time of arrival and/or a time of departure based on the geographic location. In another example, the driver can provide an estimated time of arrival. Thus, the scheduler can further leverage such data in order to manage incoming and/or outgoing traffic from the distribution center, staffing for the distribution center, and the like. Furthermore, the scheduler can manage time slots for incoming and/or outgoing traffic. For instance, based on a surge of traffic, the scheduler can issue a time slot for the driver at a later time than the estimated time (e.g., have driver wait) in order to avoid traffic within the distribution center. In one example, the scheduler can request an earlier time than the estimated time, and the scheduler can assign time slots for arrival and/or departure based on a schedule for at least one employee of the distribution center.

The aforementioned systems, components (e.g., remote authentication component, interchange manager, device, security component, verification component, reader component, security component, scheduler, service module, among others), and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

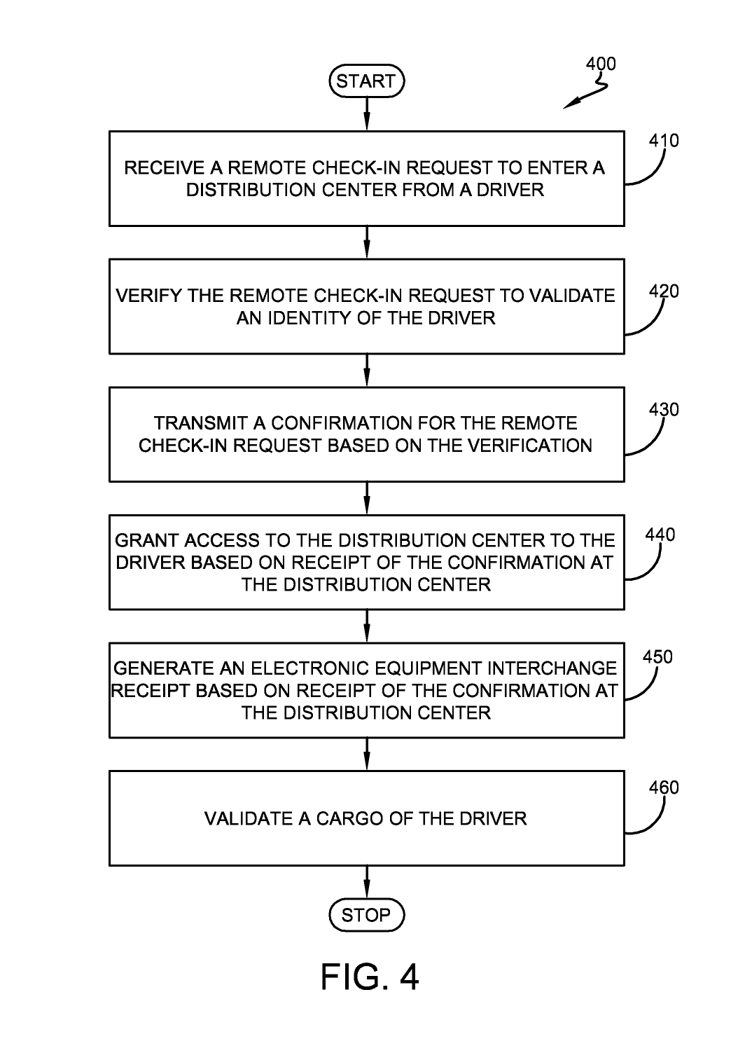

In view of the exemplary devices and elements described supra, methodologies that may be implemented in accordance with the disclosed subject matter will be better appreciated with reference to the flow charts of FIGS. 4-6. The methodologies are shown and described as a series of blocks, but the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 4 illustrates a flow chart of a method 400 for remotely checking-in with a distribution center for asset transport. At reference numeral 410, a remote check-in request to enter a distribution center can be received from a driver. (For example, the remote check-in request can be received by a remote authentication component from a device, e.g., portable device, operated by the driver. The device and remote authentication component may be remote from one another at the time when the check-in request is communicated from the device to the remote authentication component, e.g., the remote authentication component may be located inside a distribution center or other location, and the device may be located outside the distribution center or other location, including away from (e.g., one or more kilometers away from) the entrance of the distribution center or other facility.) At reference numeral 420, the remote check-in request can be verified to validate an identity of the driver. For example, the remote authentication component may verify the check-in request received from the device. At reference numeral 430, a confirmation for the remote check-in request based on the verification can be transmitted. For example, the confirmation may be transmitted from the remote authentication component to the device). At reference numeral 440, access can be granted into the distribution center to the driver based on receipt of the confirmation. (For example, the interchange manager can control access to the distribution center based on the confirmation, e.g., an informational aspect of the confirmation is communicated to the interchange manager from the device, driver, and/or otherwise, at the time when the driver seeks to enter the distribution center, with the informational aspect being compared by the interchange manager to the corresponding aspect of the confirmation as originally communicated to the device and stored in memory at the time. That is, if the informational aspect communicated from the device to the interchange manager matches the corresponding aspect stored in memory of the interchange manager, then access is granted, and if not, access is not granted.) At reference numeral 450, an electronic equipment interchange receipt can be generated based on receipt of the confirmation at the distribution center. At reference numeral 460, a cargo of the driver can be validated.

For instance, the confirmation includes an electronic equipment interchange receipt. In another instance, the remote check-in request is for a pickup of an asset within the distribution center. In still another instance, the remote check-in request is for a drop off of an asset within the distribution center. Further, the confirmation can be at least one of a password, a pass code, a pass phrase, a confirmation number, a confirmation code, a Quick Response (QR) code, a barcode, a 3-Dimensional (3D) barcode, a data file, an audio file, an image file, among others. Moreover, the receipt of the confirmation can be at least one of a scan communication, a wireless transmission, a Near Field Communication (NFC), a Radio Frequency Identification (RFID) communication, or a short-wavelength radio transmission. Still further, at least one of the remote check-in request or a remote check-out request can include at least one of a name of the driver, a cargo for the driver, a company employing the driver, or a license number for the driver. The method can include transmitting at least one of the check-in request or the check-out request from a portable device. By way of example and not limitation, the portable device can be at least one of a smartphone, a mobile device, a portable device, a portable digital assistant (PDA), a tablet, a wireless device, a wireless fidelity (Wi-Fi) device, a laptop, a portable gaming device, a device that connects to the Internet, among others.

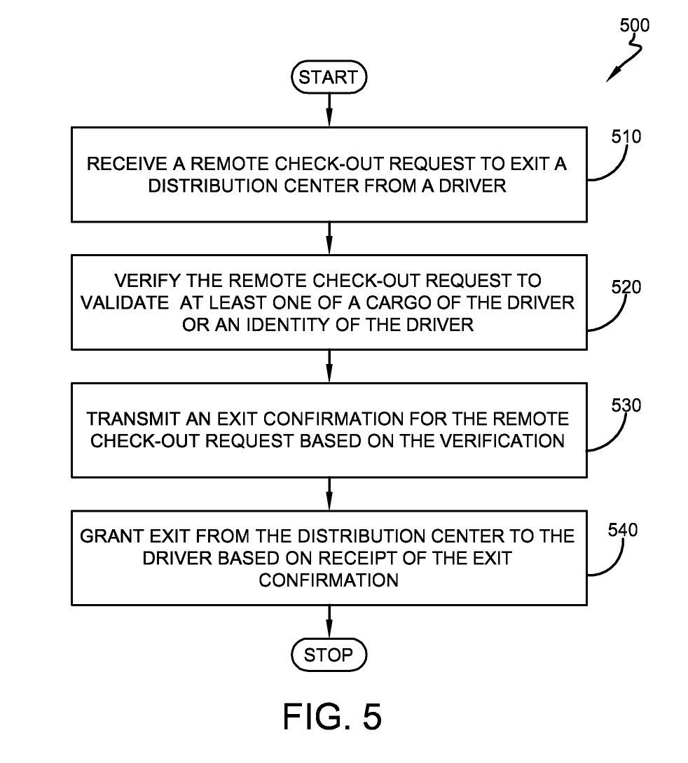

FIG. 5 illustrates a flow chart of a method 500 for remotely checking-out with a distribution center for asset transport. At reference numeral 510, a remote check-out request can be received to exit a distribution center from a driver. (For example, the remote check-out request can be received by a remote authentication component from a device operated by the driver. The device and remote authentication component may be remote from one another at the time when the check-in request is communicated from the device to the remote authentication component, e.g., the remote authentication component may be located inside a distribution center or other location, and the device may be located outside the distribution center or other location, including away from (e.g., one or more kilometers away from) the entrance of the distribution center or other facility.) At reference numeral 520, the remote check-out request can be verified to validate at least one of a cargo of the driver or an identity of the driver. (For example, the remote authentication component may verify the check-out request received from the device. At reference numeral 530, an exit confirmation for the remote check-out request can be transmitted based on the verification. For example, the confirmation may be transmitted from the remote authentication component to the device. At reference numeral 540, exit from the distribution center can be granted to the driver based on receipt of the exit confirmation. For example, the interchange manager can control exit from the distribution center based on the confirmation, e.g., an informational aspect of the confirmation is communicated to the interchange manager from the device, driver, and/or otherwise, at the time when the driver seeks to exit the distribution center, with the informational aspect being compared by the interchange manager to the corresponding aspect of the confirmation as originally communicated to the device and stored in memory at the time. That is, if the informational aspect communicated from the device to the interchange manager matches the corresponding aspect stored in memory of the interchange manager, then exit is granted, and if not, exit is not granted.)

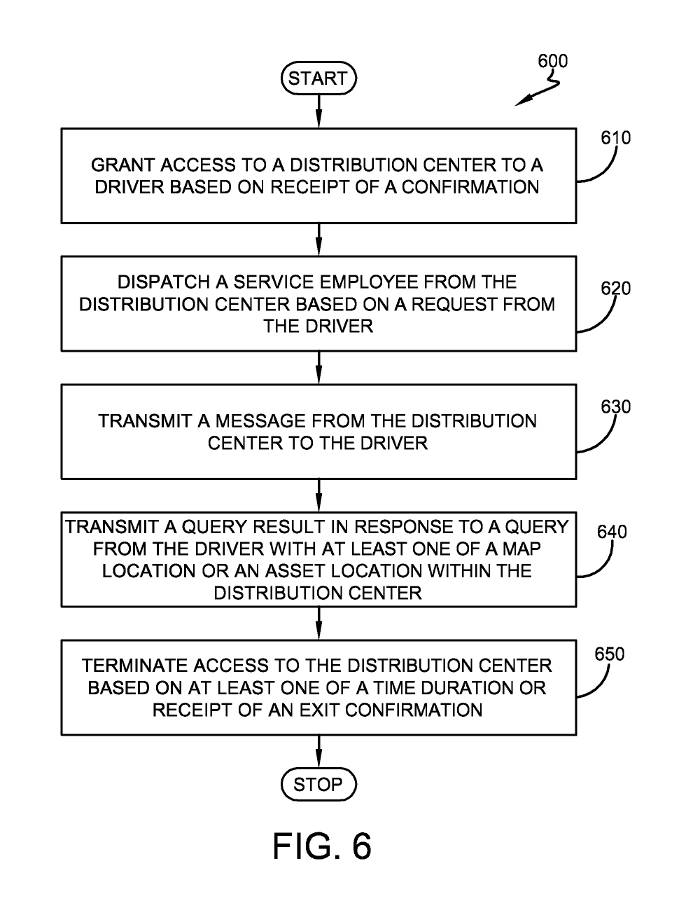

FIG. 6 illustrates a flow chart of a method 600 for providing services to a driver from a distribution center for a duration of time or during use of a valid confirmation. At reference numeral 610, access to a distribution center can be granted to a driver based on receipt of a confirmation. (For example, the interchange manager 130 can control access to the distribution center based on the confirmation, e.g., an informational aspect of the confirmation is communicated to the interchange manager from the device, driver, and/or otherwise, at the time when the driver seeks to enter the distribution center, with the informational aspect being compared by the interchange manager to the corresponding aspect of the confirmation as originally communicated to the device and stored in memory at the time. That is, if the informational aspect communicated from the device to the interchange manager matches the corresponding aspect stored in memory of the interchange manager, then access is granted, and if not, access is not granted. At reference numeral 620, a service employee from the distribution center can be dispatched to the driver based on a request from the driver. For example, the service module can receive a request from the driver via device to dispatch a service employee. At reference numeral 630, a message from the distribution center can be transmitted to the driver. For example, the service module can communicate a message to the driver received via a device. At reference numeral 640, a query result can be transmitted in response to a query from the driver with at least one of a map location or an asset location within the distribution center. For example, the service module can communicate a query result to the driver received via a device as discussed in FIG. 3. At reference numeral 650, access to the distribution center can be terminated based on at least one of a time duration or receipt of an exit confirmation. (For example, authentication component 120 can monitor an amount of time for a request check-in and/or a check-out and revoke such request based on the amount of time being at or above a threshold.)

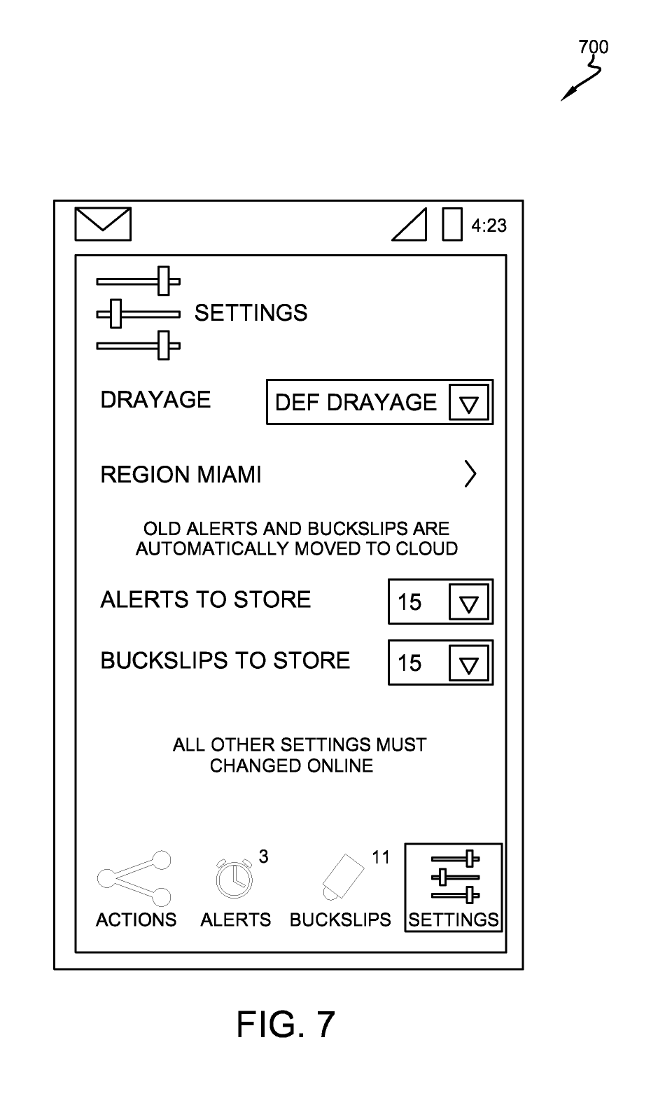

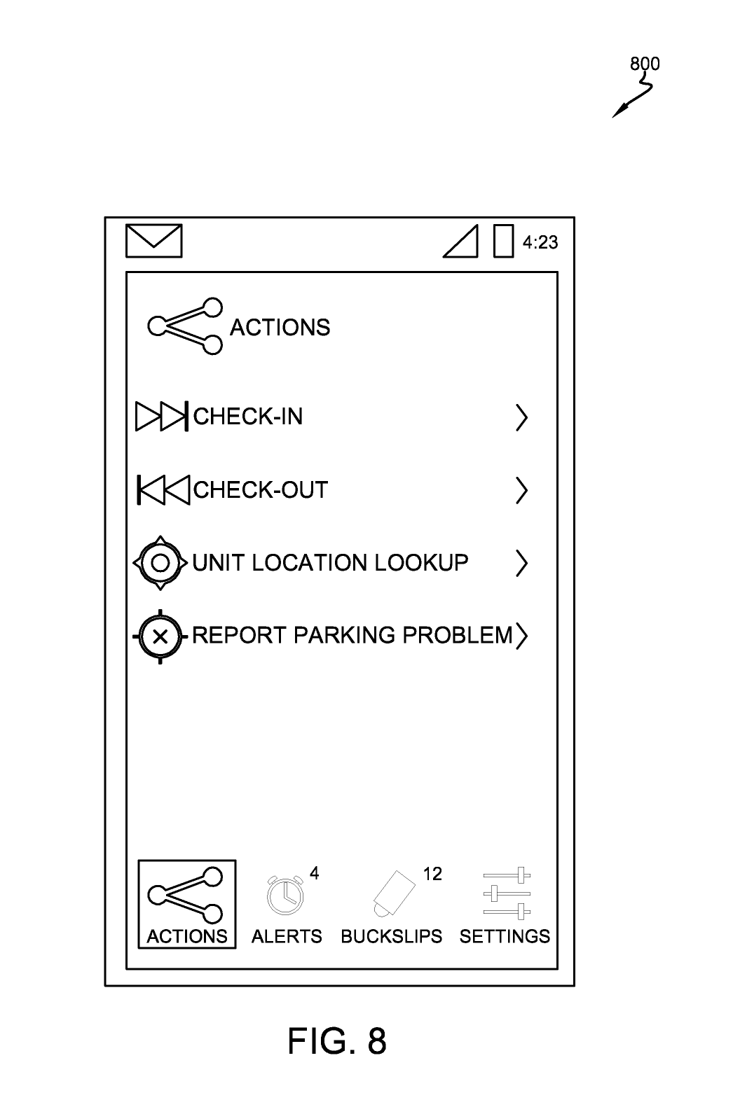

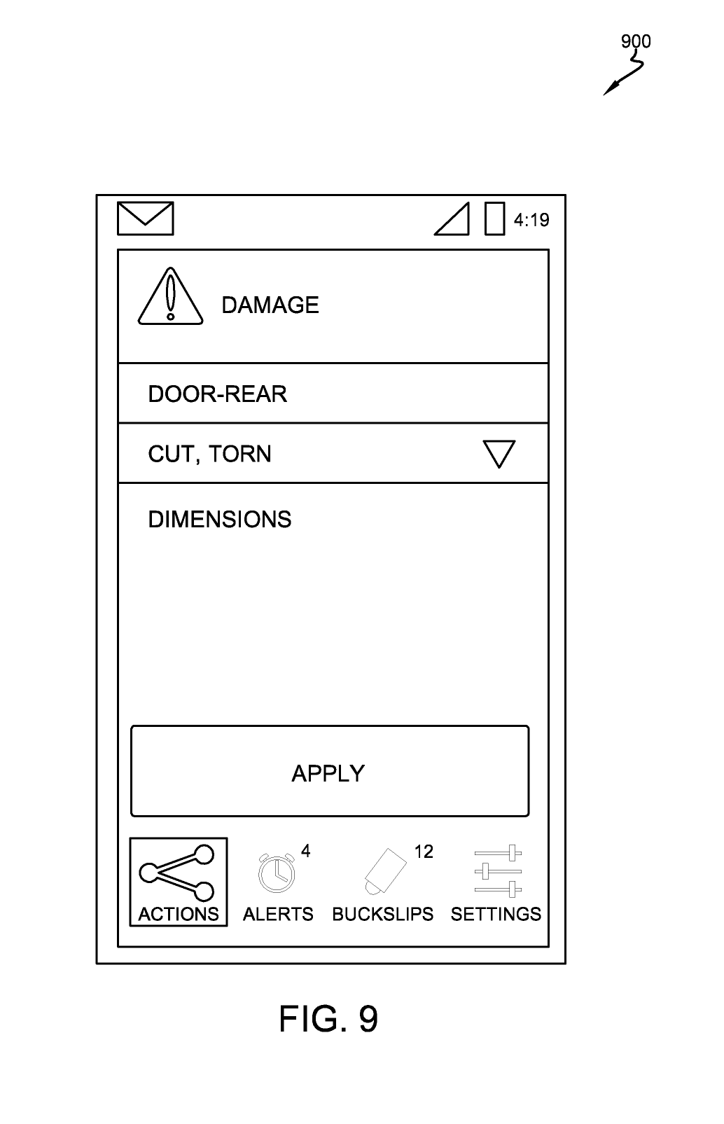

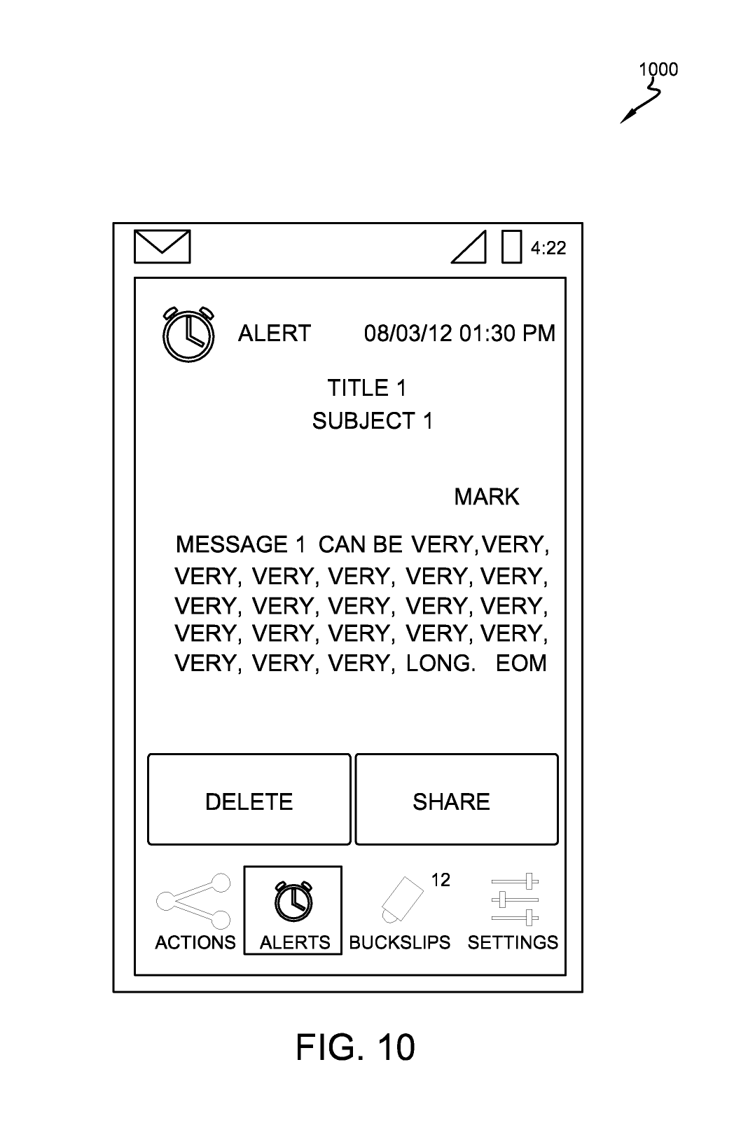

FIGS. 7-17 illustrate exemplary display screens in accordance with the disclosed systems (100, 200, and 300) and methods (400, 500, and 600). The display screens are solely for illustrative purposes. FIG. 7 illustrates a display screen 700 that includes a displayed settings layout in which a user can define personal settings and/or customization. FIG. 8 illustrates a display screen 800 that includes displayed available actions for a user. The actions include, but are not limited to, check-in, check-out, unit location lookup, report parking problem, among others. FIG. 9 depicts a display screen 900 that includes a displayed add damage option. The damage can be identified by area (e.g., door, rear, among others) and a type of damage (cut, torn, among others); a dimensions tab may also be displayed to input the estimated dimensions of the damaged area. FIG. 10 illustrates a display screen 1000 that includes a displayed alert received. For instance, the alert can be a message related to delays, weather, other status, security alerts, safety levels, backlogs and traffic jams, among others.

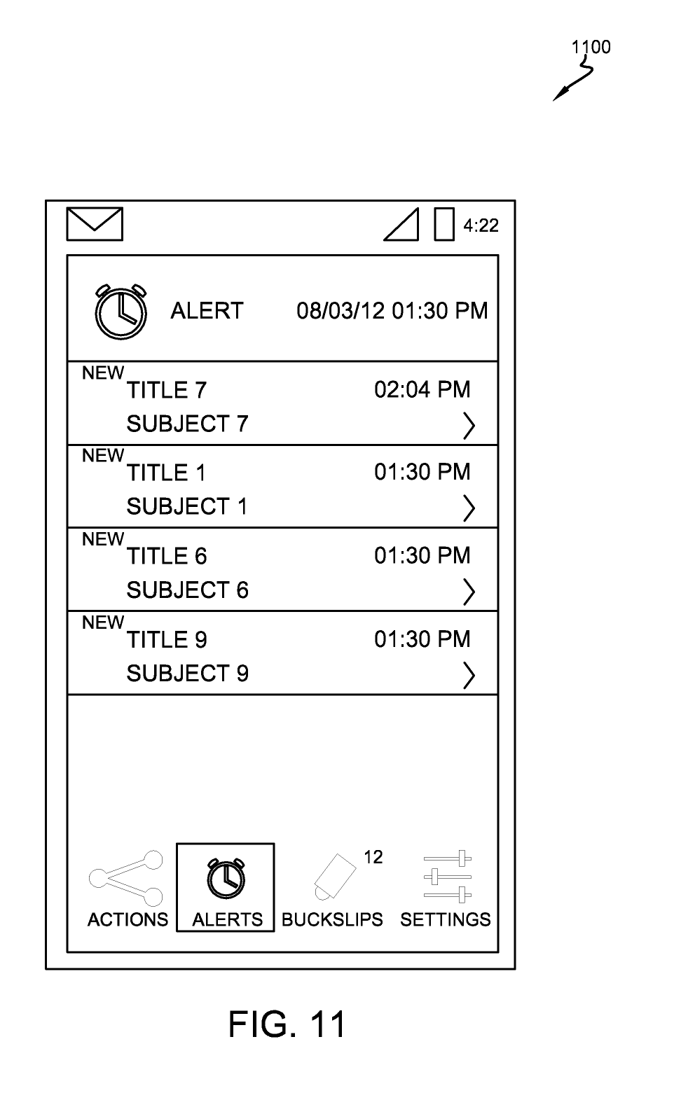

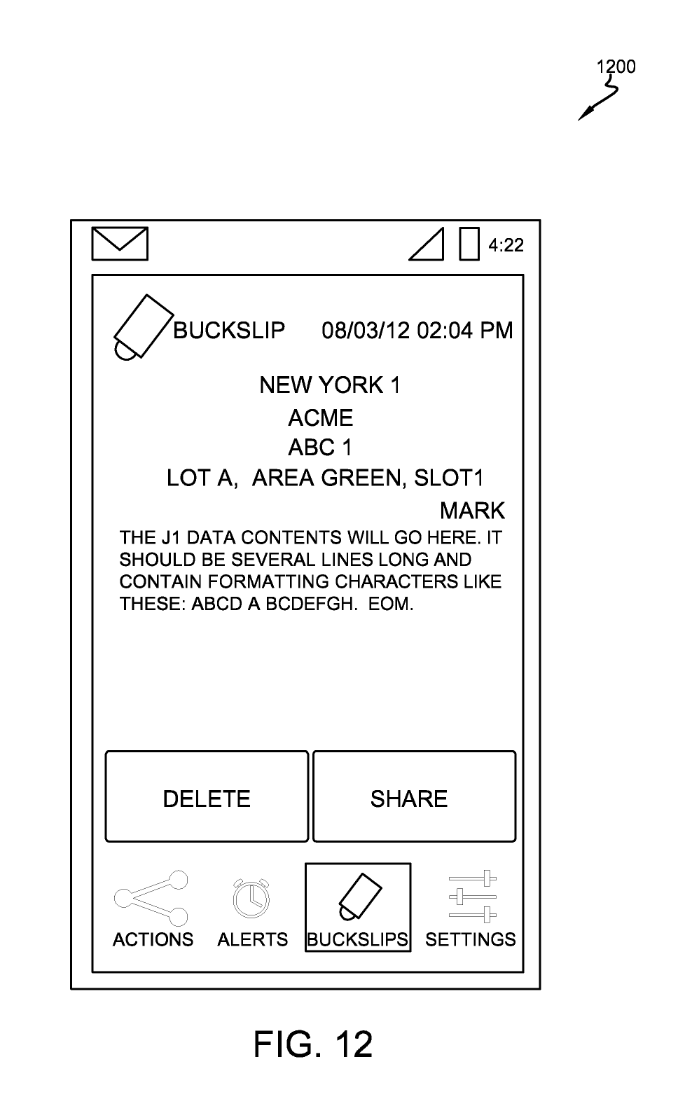

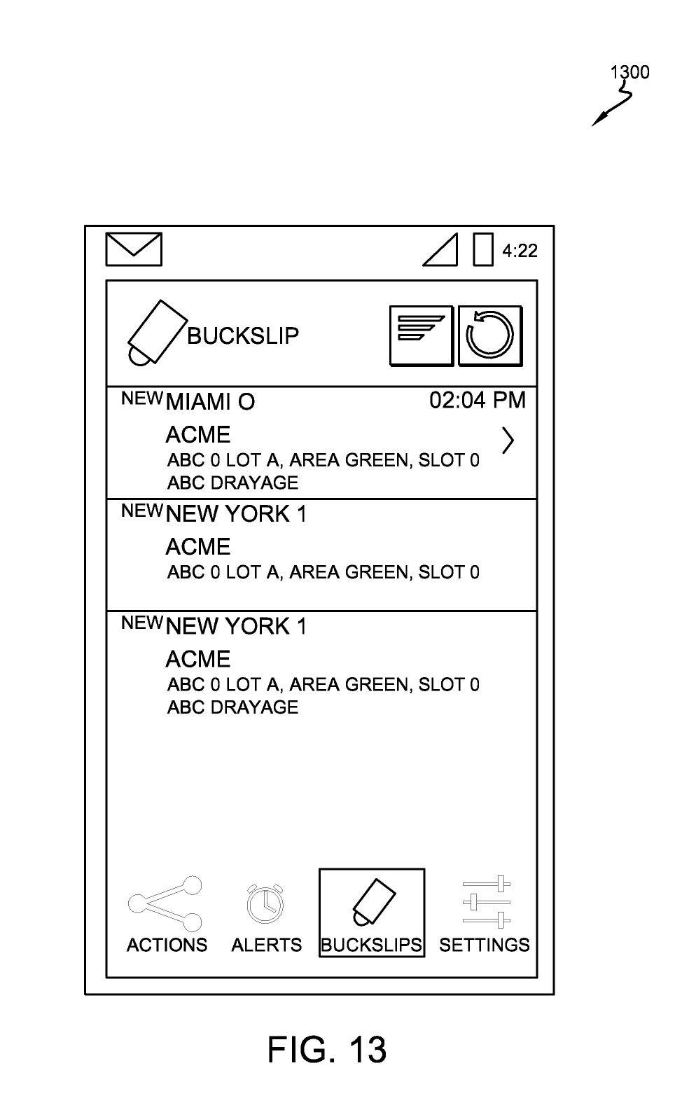

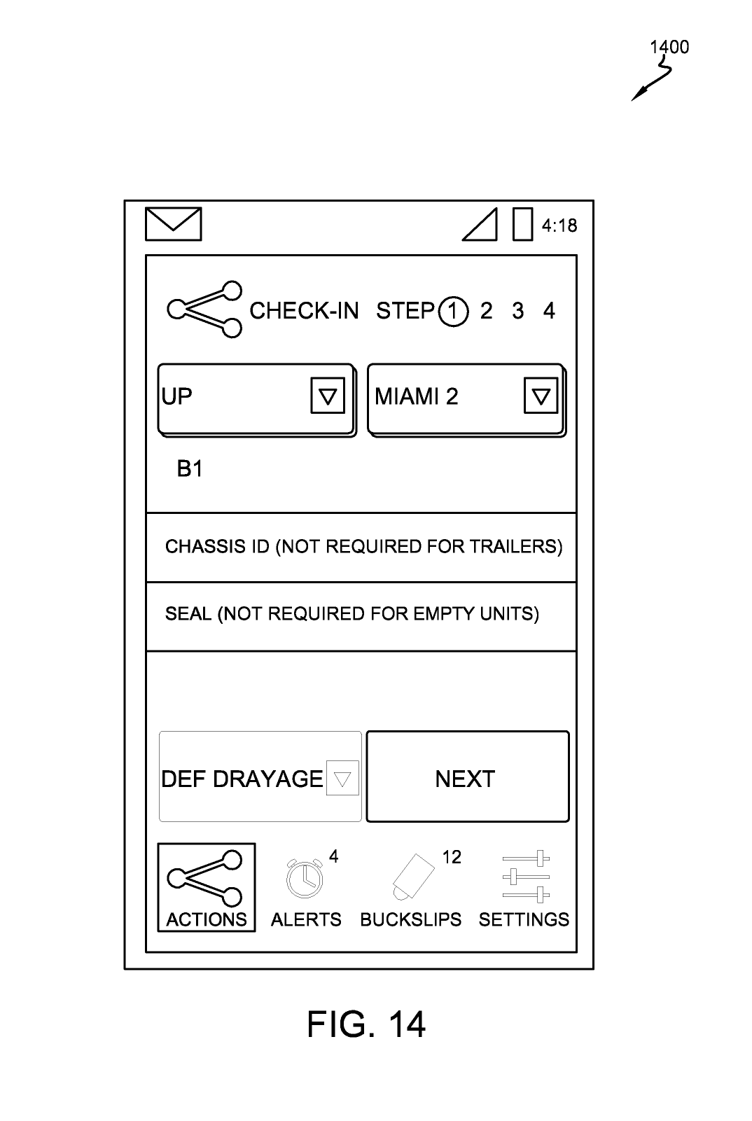

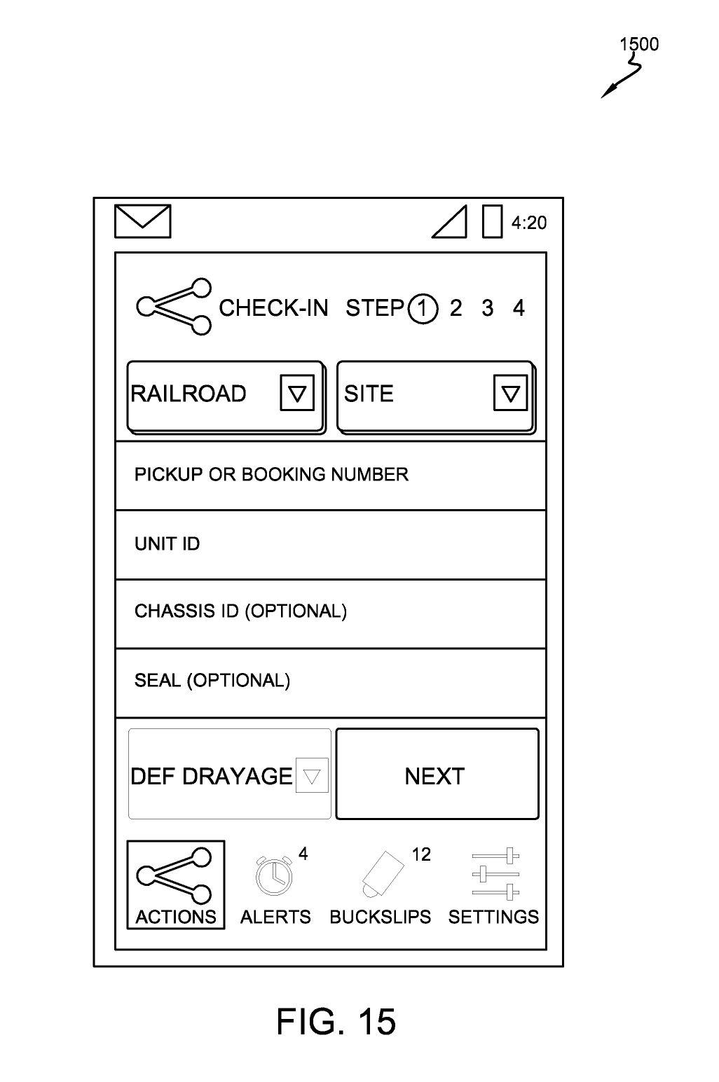

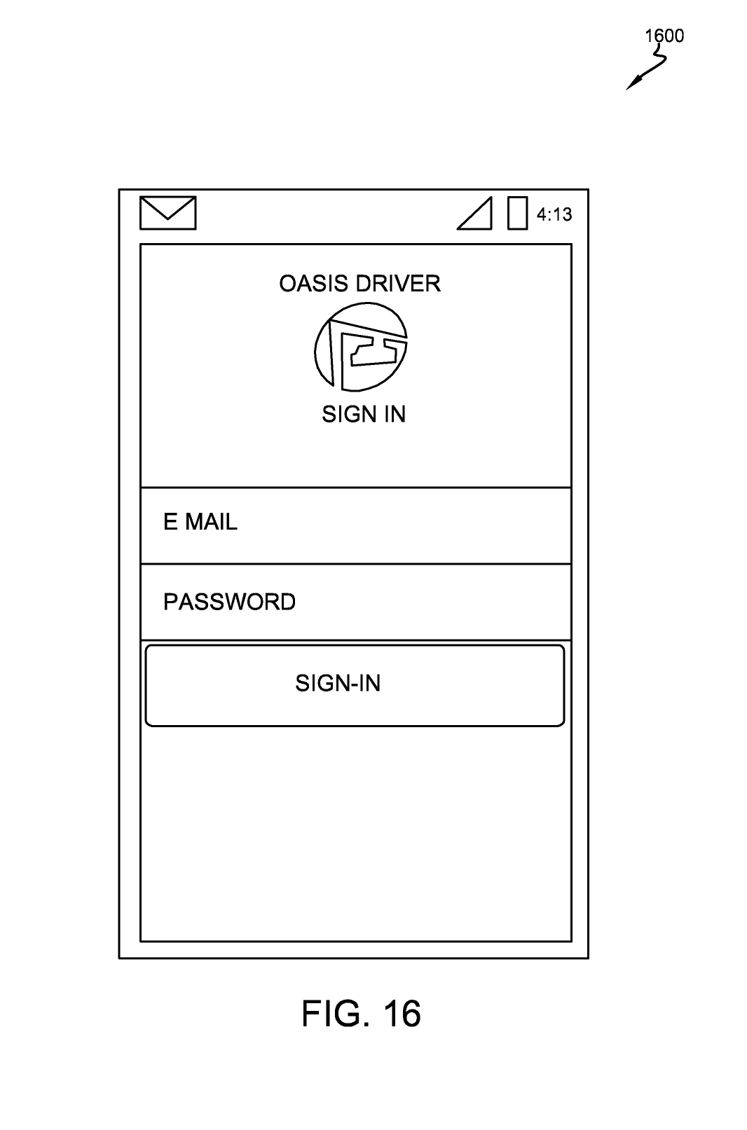

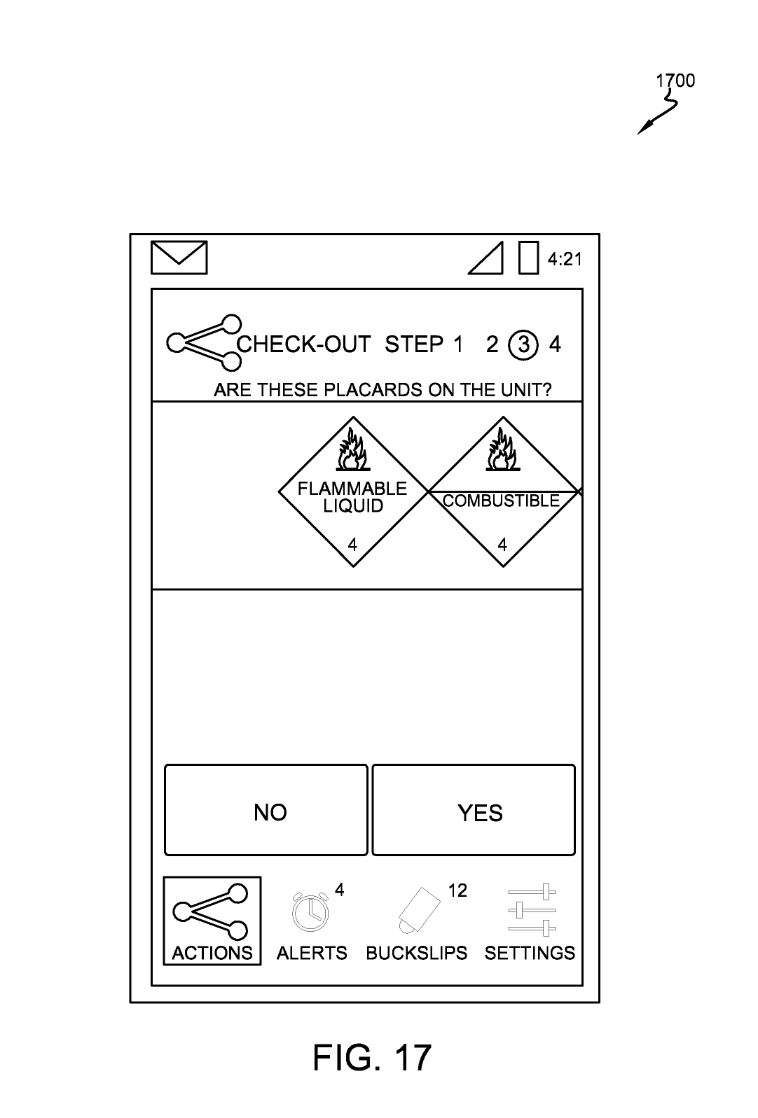

FIG. 11 illustrates a display screen 1100 that provides a history of messages and/or alerts. For example, the alerts or messages can be listed in chronological order, title, subject, among others. FIG. 12 depicts a display screen 1200 that includes displayed asset information for pickup and/or a drop off. For instance, the display screen can include information such as address of a distribution center, location within the distribution center, directions, landmarks for identification during travel, among others. FIG. 13 illustrates a display screen 1300 that includes asset information listing for more than one pickup and/or drop off. FIG. 14 depicts a display screen 1400 that includes a displayed check-in for a user and/or vehicle with a distribution center. FIG. 15 illustrates a display screen 1500 that includes a displayed check-out for a user and/or vehicle with a distribution center. FIG. 16 depicts a display screen 1600 that illustrates a sign in, log in, and/or authentication for a user and/or a vehicle. FIG. 17 illustrates a display screen 1700 that includes displayed indications/notifications for a cargo or asset. In an embodiment, the display screen can include placards for a particular asset delivery or transport. In another embodiment, the display screen can include warning or instructions to the user (e.g., driver) or vehicle. Video capture functionality may be used by the device to capture a placard disposed on the vehicle and compare the captured image to an expected placard determined by the cargo type. A mismatch of displayed placard to expected placard may trigger an alert, and may deny entry of the vehicle into the facility.

In an embodiment, a method can include generating an electronic equipment interchange receipt with the confirmation. In an embodiment, the method can include verifying the remote check-in request. In an embodiment, the verifying of the remote check-in request includes checking if a pickup location of an asset is within the distribution center or if the asset itself is within the distribution center. In an embodiment, the verifying of the remote check-in request includes checking if a drop off location of an asset is within the distribution center. In an embodiment, the method includes validating a cargo of the driver. In an embodiment, the confirmation includes supplying at least one of a password, a pass code, a pass phrase, a confirmation number, a confirmation code, a Quick Response (QR) code, a barcode, a 3-dimensional (3D) barcode, a data file, an audio file, a synchronized hardware token, or an image file.

In an embodiment, the confirming of the remote check-in request includes sending information via a scan communication, a wireless transmission, a Near Field Communication (NFC), a Radio Frequency Identification (RFID) communication, or a short-wavelength radio transmission. In an embodiment, the method includes at least one of receiving a remote check-out request to exit the distribution center from the driver; verifying the remote check-out request to validate at least one of an identity of the driver or a cargo associated with the driver; transmitting an exit confirmation for the remote check-out request based at least in part on the verification; or granting exit to the driver based on receipt of the exit confirmation.

In an embodiment, the method further including in at least one of the remote check-in request or the remote check-out request at least one of a name of the driver, a cargo for the driver, a company employing the driver, or a license number for the driver. In an embodiment, the method includes transmitting at least one of the check-in request or the check-out request from a portable device. In an embodiment, the portable device comprises a smartphone, a portable digital assistant (PDA), a tablet, a wireless fidelity (Wi-Fi) equipped device, or a laptop computer, and further comprising accessing the portable device.

In an embodiment, the method includes requesting a service from the distribution center via the portable device. In an embodiment, the method includes receiving a message from the distribution center via the portable device. In an embodiment, the method includes rendering map information associated with the distribution center via the portable device.

In an embodiment, a system can be provided that includes a third component configured to dispatch a service to the driver. In an embodiment, the third component is operable to communicate a message from the distribution center to the driver. In an embodiment, the third component operable to generate a query result for a query from the driver.

In an embodiment, a system can be provided that includes at least one of means for transmitting an authorization request on behalf of a driver for a distribution center (e.g., first component, second component, third component, combination thereof, among others); means for verifying an identity of the driver and creating an electronic confirmation based on the verified identity (e.g., first component, second component, third component, combination thereof, among others); means for submitting the electronic confirmation to the distribution center; and means for granting least one of an entry to the distribution center or an exit from the distribution center based at least in part on the submitted electronic confirmation (e.g., first component, second component, third component, combination thereof, among others).

In an embodiment of the system, the driver enters or exits the distribution center to transport an asset based on the electronic confirmation. The embodiment can include means for dispatching a service to the driver (e.g., first component, second component, third component, combination thereof, among others). In the embodiment, the system can include means for communicating a message from the distribution center to the driver (e.g., first component, second component, third component, combination thereof, among others).

In an embodiment, a method is provided that includes at least the steps of:

receiving a remote check-in request to enter a distribution center from a driver, wherein the remote check-in request is received from the driver at a location remote from an entrance to the distribution center and before a time when the driver arrives at the entrance to the distribution center, and wherein the remote check-in request is received by a remote authentication component from a device operated by the driver; validating, automatically with the remote authentication component, an identity of the driver; prior to the time the driver arrives the entrance to the distribution center, confirming, with an interchange manager component, the remote check-in request based at least in part on the validating of the identity; and granting access into the distribution center to the driver based at least in part the confirmation. As used herein, “remote” is considered to a distance from an exit and/or entrance to a distribution center. For instance, The device 110 and remote authentication component 120 may be remote from one another at the time when the check-in request and/or check-out request is communicated from the device to the remote authentication component, e.g., the remote authentication component may be located inside a distribution center or other location, and the device may be located outside the distribution center or other location, including away from (e.g., one or more kilometers away from) the entrance of the distribution center or other facility. Additionally, “before a time” can be 5 minutes, 10 minutes, 20 minutes, etc. minutes before, wherein the minutes before is a duration of time that is substantial rather than in seconds (e.g., under one minute).

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method, comprising:
receiving a remote check-in or check-out request from a driver to traverse a gate at a distribution center, wherein the remote check-in or check-out request comprises at least identity information relating to at least one of a driver, a vehicle, or vehicle cargo;
validating at a site remote from the gate at least one of an identity of the driver, the vehicle, or the vehicle cargo based on the identity information; and
granting access through the gate of the distribution center based at least in part on a confirmation that includes an electronic receipt.

2. The method of claim 1, wherein receiving the remote check-in request is performed prior to the vehicle, the driver, or both the vehicle and the driver arriving at the gate.

3. The method of claim 1, further comprising confirming the identity by supplying at least one of a password, a pass code, a pass phrase, a confirmation number, a confirmation code, a Quick Response (QR) code, a barcode, a three dimensional (3D) barcode, a data file, an audio file, a synchronized hardware token value, or an image file and comparing such against a determined relationship of the driver, vehicle or cargo and a determined check-in or check-out transport event.

4. The method of claim 3, wherein the step of confirming further comprises sending information via a scan communication, a wireless transmission, a Near Field Communication (NFC), a Radio Frequency Identification (RFID) communication, or a short-wavelength radio transmission.

5. The method of claim 1, further comprising including in at least one of the remote check-in request or the remote check-out request at least one of a name of the driver, information about the vehicle cargo, a company employing the driver, or a license number for the driver.

6. The method of claim 1, further comprising transmitting at least one of the check-in request or the check-out request from a portable device operated by the driver.

7. The method of claim 6, further comprising rendering map information associated with the distribution center via a display screen on the portable device.

8. The method of claim 7, further comprising indicating on the rendered map information associated with at least one of a location of an asset for pick up, or a location of a drop off point for the vehicle cargo.

9. The method of claim 8, further comprising indicating on the rendered map information associated pathways from the gate to at least one of the location of the asset, the drop off point, or to a vehicle service location.

10. The method of claim 1, further comprising requesting a service for the vehicle or for the driver, or both the vehicle and the driver with the remote check-in or check-out request.

11. The method of claim 1, wherein the remote check-in request includes information about the vehicle cargo, and the method further comprises providing confirmation information about handling procedures for the vehicle cargo based at least in part on the vehicle cargo information received in the remote check-in request.

12. The method of claim 11, wherein the vehicle cargo is hazardous, and the method further comprises including in the handling procedures information for areas to avoid traversing with the vehicle cargo, information on proper placarding of the vehicle, or if a map is rendered then graphically indicating on the map such areas to avoid traversing with the hazardous cargo.

13. The method of claim 1, further comprising:
verifying the remote check-in by checking if one or both of:
a determined pickup location of an asset is within the distribution center or if the asset itself is within the distribution center; or
a determined pickup time for the asset is within a determined time tolerance period for the pickup of the asset.

14. The method of claim 13, wherein the confirmation comprises information on at least one of a security or safety alert situation at the distribution center, an anticipated delaying event on at least one path from the vehicle location to the gate, weather conditions at the distribution center, and a backlog of transport activity at the distribution center.

15. The method of claim 13, wherein the remote check-in request comprises information on at least one of:
a location of the vehicle, driver or both vehicle and driver at the time the remote check-in request is made;
a direction or rate of travel of the vehicle at the time the remote check-in request is made; or
an estimated arrival time of the vehicle at the gate.

16. The method of claim 15, further comprising pre-staging an asset for pick-up at the distribution center at a pick-up location based at least in part on an estimated or calculated arrival time of the vehicle either at the gate or at the pick-up location.

17. The method of claim 1, further comprising:
receiving the remote check-out request to exit the distribution center from the driver;
verifying the remote check-out request to validate at least one of the identity of the driver or a cargo associated with the driver;
transmitting an exit confirmation for the remote check-out request based at least in part on the verification; and
granting exit to the driver based on receipt of the exit confirmation.

18. A system, comprising:
a device configured to transmit an authorization request on behalf of a driver for a distribution center, wherein the device is configured to transmit the authorization request via a computer network, the device comprising:
a first component operable to verify an identity of the driver, and the first component further configured to create an electronic confirmation based on the verified identity and to submit the electronic confirmation to the distribution center; and
a second component configured to grant at least one of an entry to the distribution center or an exit from the distribution center based at least in part on the submitted electronic confirmation so that the driver can enter or exit the distribution center to transport an asset based on at least in part on the electronic confirmation.

19. The system of claim 18, further comprising a third component configured to dispatch a service vehicle to a location of at least one of the driver, the vehicle, the vehicle cargo, wherein the service vehicle is configured to provide at least one of fuel, food, or maintenance.

20. A system, comprising:
means for transmitting an authorization request on behalf of a driver for a distribution center;
means for verifying an identity of the driver and creating an electronic confirmation based on the verified identity;
means for submitting the electronic confirmation to the distribution center; and
means for granting least one of an entry to the distribution center or an exit from the distribution center based at least in part on the submitted electronic confirmation.
